(19) United States
(12) Patent Application Publication
(10) Pub. No.: US 2011/0310222 A1
(43) Pub. Date: Dec. 22, 2011

(54) IMAGE DISTRIBUTING APPARATUS, DISPLAY APPARATUS, AND IMAGE DISTRIBUTING METHOD THEREOF

(75) Inventors: Ji-won KIM, Seoul (KR); Kyung-Hwan LEE, Suwon-si (KR)

(73) Assignee: SAMSUNG ELECTRONICS CO., LTD., Suwon-si (KR)

(21) Appl. No.: 13/043,814

(22) Filed: Mar. 9, 2011

(30) Foreign Application Priority Data
Jun. 22, 2010 (KR) 2010-0059182

(51) Int. Cl. H04N 5/06; H04N 13/00; H04N 7/01

(52) U.S. Cl. 348/43; 348/501; 348/441; 348/E05.011; 348/E07.003; 348/E13.025

(57) ABSTRACT

An image distributing apparatus, a display apparatus, and an image distributing method thereof are provided. The image distributing apparatus includes: an image input unit which receives an input signal comprising an image signal and a first sync signal for synchronizing a display of the image signal; a sync signal regeneration unit which generates a second sync signal having a frequency that is different from a frequency of the first sync signal; and an image output unit comprising at least one output port to output the image signal and the second sync signal. Accordingly, a plurality of display apparatuses connected to the image distributing apparatus can synchronize a time with an image is displayed with each other.

### CROSS-REFERENCE TO RELATED APPLICATION

This application claims priority from Korean Patent Application No. 10-2010-0059182, filed on Jun. 22, 2010 in the Korean Intellectual Property Office, the disclosure of which is incorporated herein in its entirety by reference.

### BACKGROUND

1. Field

Exemplary embodiments relate to an image distributing apparatus, a display apparatus, and an image distributing method, and more particularly, to an image distributing apparatus which distributes an input image to at least one external apparatus, a display apparatus, and an image distributing method thereof.

2. Description of the Related Art

Three-dimensional (3D) stereoscopic image technology is applicable to various fields, including information communication, broadcasting, medicine, education and training, military, gaming, animation, virtual reality, computer aided drafting (CAD), industrial technologies, etc., and is regarded as a core base technology for next generation 3D stereoscopic multimedia information communication, which is used in all the aforementioned fields.

Generally, a stereoscopic sense that a person perceives occurs from a complex effect of a degree of a change of thickness of the person's eye lens according to a location of an object to be observed, an angle difference of the object observed from both eyes, differences of location and shape of the object observed from both eyes, a time difference due to a movement of the object, and other various psychological and memory characteristics.

In particular, binocular disparity, caused by about a 6˜7 cm lateral distance between the person's left eye and right eye, may be regarded as an important cause of the stereoscopic sense. Due to the binocular disparity, the person perceives the object with an angle difference, which causes the left eye and the right eye to receive different images. Accordingly, when these two images are transmitted to the person's brain through retinas, the brain can perceive the original 3D stereoscopic image by combining the two pieces of information.

Stereoscopic image display apparatuses include glasses-type apparatuses which use special glasses and nonglasses-type apparatuses which do not use such special glasses. A glasses-type apparatus may adopt a color filtering method which separately selects images by filtering colors that are in mutually complementary relationships, a polarized filtering method which separates the images received by a left eye from those received by a right eye using a light-shading effect caused by a combination of polarized light elements meeting at right angles, or a shutter glasses method which enables a person to perceive a stereoscopic sense by blocking a left eye and a right eye alternately in response to a sync signal which projects a left image signal and a right image signal to a screen.

A stereoscopic image includes a left eye image perceived by a left eye and a right eye image perceived by a right eye, and a stereoscopic image display apparatus creates a stereoscopic sense using a time difference between the left eye image and the right eye image.

Meanwhile, in a shutter glasses method, if a plurality of stereoscopic display apparatuses display images simultaneously and the plurality of stereoscopic display apparatuses are viewed by a single pair of 3D glasses, the sync signals output from each of the stereoscopic display apparatuses may not be consistent with each other. In this case, a time when a left eye image and a right eye image of a stereoscopic image output from the plurality of stereoscopic display apparatuses are displayed alternately may differ. Thus, it is difficult to view a stereoscopic image displayed from the plurality of stereoscopic display apparatuses with the single pair of 3D glasses appropriately.

Accordingly, a method of synchronizing the time when a plurality of stereoscopic display apparatuses display an image is desired.

### SUMMARY

One or more exemplary embodiments relate to an image distributing method which generates a sync signal whose frequency is different from a frequency of a sync signal of an input image and outputs an image signal including the generated sync signal, a display apparatus, and an image distributing method thereof.

According to an aspect of an exemplary embodiment, there is provided an image distributing apparatus, including: an image input unit which receives an input signal including an image signal and a first sync signal; a sync signal regeneration unit which generates a second sync signal having a frequency that is different from a frequency of the first sync signal; and an image output unit which includes at least one output port to output an image signal including the second sync signal.

The sync signal regeneration unit may generate the second sync signal having the frequency which is determined based on a frame rate conversion (FRC) unit.

The sync signal regeneration unit may generate the second sync signal having a frequency in which a number of frames corresponding to a number of FRC units are included in one period.

The image signal may be a stereoscopic image in a 24 Hz frame packing format, a frequency of the first sync signal may be 24 Hz, and a frequency of the second sync signal may be 6 Hz.

The image signal may be a stereoscopic image in a 48 Hz frame sequential format, the frequency of the first sync signal may be 48 Hz, and the frequency of the second sync signal may be 6 Hz.

The sync signal regeneration unit may generate the second sync signal if the image signal is a stereoscopic image, and output the first sync signal as is if the image signal is not the stereoscopic image.

The sync signal regeneration unit may include a latch circuit which generates the second sync signal.

The sync signal regeneration unit may include a programmable logic circuit to generate the second sync signal.

The first sync signal may be a vertical (V) sync included in the image signal.

The image input unit and the image output unit may be compatible with at least one HDMI standard.

The image output unit may include a plurality of output ports, and the second sync signal may be simultaneously output from the plurality of output ports.

According to an aspect of another exemplary embodiment, there is provided an image distributing method, including receiving an input signal including an image signal and a first sync signal, generating a second sync signal having a frequency that is different from frequency of the first sync signal, and outputting an image signal including the second sync signal through at least one output port.

The generating may include generating the second sync signal having the frequency that is determined based on a FRC unit.

The generating may include generating the second sync signal having the frequency in which a number of frames corresponding to a number of FRC units are included in one period.

The image signal may be a stereoscopic image in a 24 Hz frame packing format, the frequency of the first sync signal may be 24 Hz, and the frequency of the second sync signal may be 6 Hz.

The image signal may be a stereoscopic image in a 48 Hz frame sequential format, the frequency of the first sync signal may be 48 Hz, and the frequency of the second sync signal may be 6 Hz.

The generating may include determining whether the image signal is a stereoscopic image, generating the second sync signal if the image signal is the stereoscopic image, and outputting the first sync signal as is if the image signal is not the stereoscopic image.

[28] The generating may generate the second sync signal using a latch circuit.

The generating may generate the second sync signal using a programmable logic circuit.

The first sync signal may be a V sync included in the image signal.

The image signal may be compatible with at least one HDMI standard.

The outputting may output the second sync signal through a plurality of output ports.

According to an aspect of another exemplary embodiment, there is provided a display apparatus including the above-described image distributing apparatus.

According to an aspect of another exemplary embodiment, there is provided an image distributing method, including: receiving a first sync signal for synchronizing a display of an image signal; generating a second sync signal for synchronizing the display of the image signal and having a frequency that is different from a frequency of the first sync signal; and outputting the second sync signal through at least one output port.

As described above, according to one or more exemplary embodiments, an image distributing apparatus which generates a sync signal having a frequency that is different from a frequency of a sync signal of an input image and which outputs an image signal including the generated sync signal, a display apparatus, and a image distributing method thereof are provided. Accordingly, a plurality of display apparatuses connected to an image distributing apparatus may synchronize a time when an image is displayed.

In particular, if a 3D image is displayed, 3D images displayed on a plurality of display apparatuses may be synchronized with each other.

### BRIEF DESCRIPTION OF THE DRAWINGS

The above and/or other aspects will be more apparent by describing certain exemplary embodiments with reference to the accompanying drawings, in which:

FIG. 1 is a schematic view illustrating an image distributing system according to an exemplary embodiment;

FIG. 2 is a block diagram illustrating a configuration of an image distributing apparatus according to an exemplary embodiment;

FIG. 3A is a view illustrating a sync signal regeneration unit using a latch circuit according to an exemplary embodiment;

FIG. 3B is a view illustrating a sync signal regeneration unit using a programmable logic circuit according to an exemplary embodiment;

FIG. 4 is a flowchart to explain an image distributing method according to an exemplary embodiment;

FIG. 5 is a view illustrating an input signal and an output signal of an image distributing apparatus according to an exemplary embodiment;

FIGS. 6A 6B are views to compare a case where an image distributing apparatus according to an exemplary embodiment is used to a case where an image distributing apparatus is not used;

FIG. 7A is a block diagram illustrating a television in which an image distributing apparatus is installed according to an exemplary embodiment;

FIG. 7B is a view illustrating an image distributing system including a television in which an image distributing apparatus is installed according to an exemplary embodiment; and

FIG. 8 is a block diagram illustrating a configuration of a television which receives an image signal from an image distributing apparatus and displays the received image signal according to an exemplary embodiment.

### DETAILED DESCRIPTION OF EXEMPLARY EMBODIMENTS

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the exemplary embodiments with unnecessary detail. It is understood that expressions such as “at least one of,” when preceding a list of elements, modify the entire list of elements and do not modify the individual elements of the list.

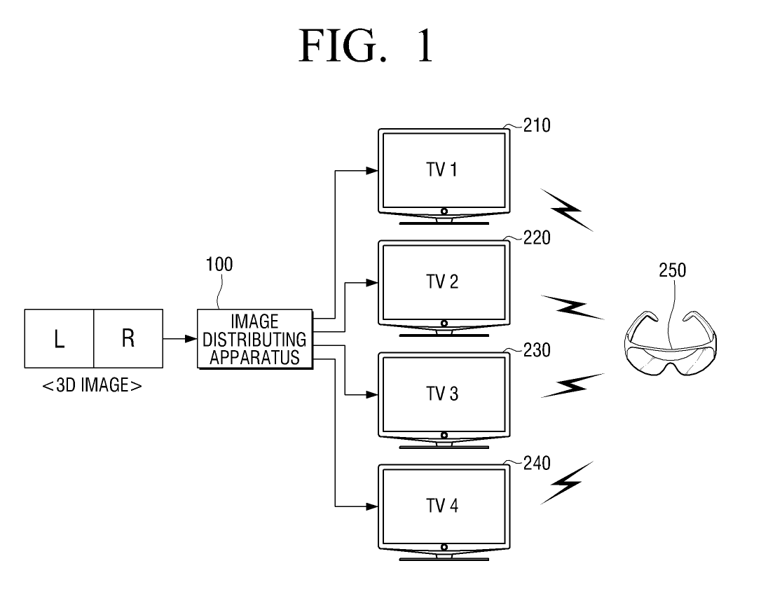

FIG. 1 is a schematic view illustrating an image distributing system according to an exemplary embodiment. Referring to FIG. 1, the image distributing system includes an image distributing apparatus 100 and a plurality of televisions 210, 220, 230, 240.

The image distributing apparatus 100 receives an image from an external image apparatus and outputs at least one input image through an output port. While in FIG. 1, the image distributing apparatus 100 outputs an image through four output ports, it is understood that another exemplary embodiment is not limited thereto. That is, in another exemplary embodiment, any number of output ports through which the image distributing apparatus 100 can output an image may be provided. Each of a plurality of televisions 210, 220, 230, 240 displays an input image.

As such, the image distributing system displays a single input image on a plurality of televisions 210, 220, 230, 240 through the image distributing apparatus 100.

In this case, if the input image is a stereoscopic image including a left eye image (L image) and a right eye image (R image), a user views the stereoscopic image through 3D glasses 250. Since the user views the stereoscopic image displayed on a plurality of televisions 210, 220, 230, 240 through the single pair of 3D glasses 250, a time when the stereoscopic image displayed on each of the plurality of televisions 210, 220, 230, 240 is output is to be synchronized with each other.

In particular, the image distributing apparatus 100 generates a second sync signal which has a different frequency from the frequency of a sync signal of an input image (hereinafter, referred to as a first sync signal). Specifically, the image distributing apparatus 100 generates the second sync signal having a frequency that is determined based on units of frame rate conversion (FRC). In this case, the second sync signal has a frequency in which a number of frames corresponding to a number of units of FRC are included in one period.

Herein, the sync signal may be a vertical sync signal (V Sync) included in an image signal. For example, FRC may be performed and a sync signal to control 3D glasses 250 may be generated based on the V Sync.

A detailed description of operations of the image distributing apparatus 100 will be provided later. As described above, the time when a stereoscopic image is displayed on each of the plurality of televisions 210, 220, 230, 240 is synchronized with each other in an image distributing system, and thus a user may view the stereoscopic image displayed on each of the plurality of televisions 210, 220, 230, 240 through the single pair of 3D glasses 250.

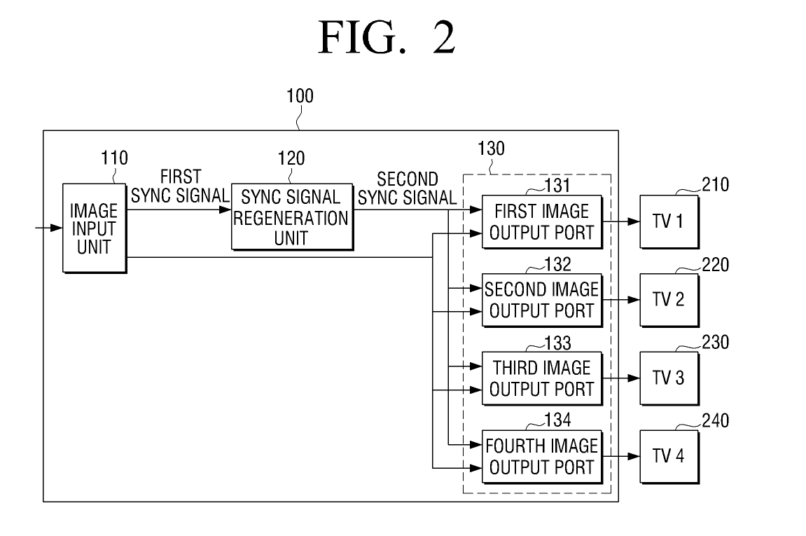

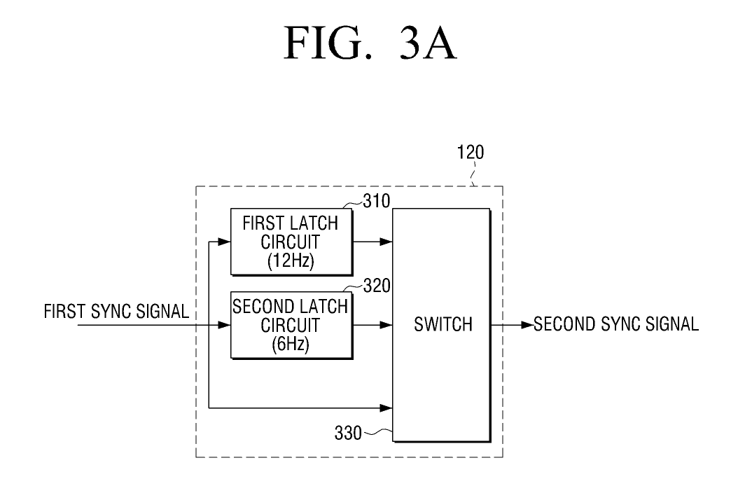

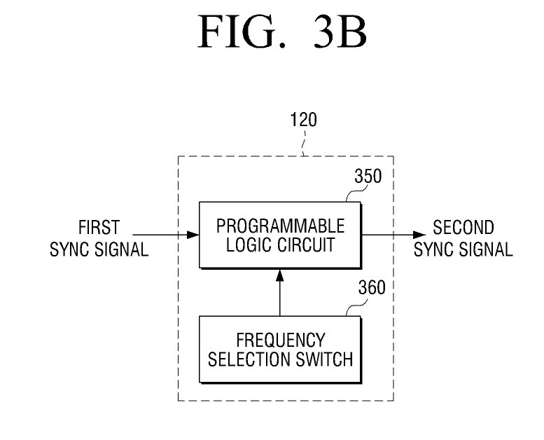

Hereinafter, a configuration of an image distributing apparatus 100 according to one or more exemplary embodiments will be explained in detail with reference to FIGS. 2, 3A, and 3B.

FIG. 2 is a block diagram illustrating a configuration of an image distributing apparatus 100 according to an exemplary embodiment. Referring to FIG. 2, the image distributing apparatus 100 includes an image input unit 110, a sync signal regeneration unit 120, and an image output unit 130.

The image input unit 110 receives an image signal including a first sync signal. For example, the image input unit 110 may receive an image signal from a digital video disc (DVD) player or a Blu-ray (BD) player. Furthermore, the image input unit 110 may receive an image signal via broadcasting through a broadcast reception antenna or a tuner.

The image input unit 110 may include at least one of various types of image interfaces. For example, the image input unit 110 may include at least one of a digital video/visual interactive (DVI) interface or a high-definition multimedia interface (HDMI). Moreover, the image input unit 110 may receive a stereoscopic image signal including a left eye image and a right eye image.

For example, if the image input unit 110 is compatible with HDMI standards, the image input unit 110 may receive a stereoscopic image in a 24 Hz frame packing format.

The image input unit 110 transmits the first sync signal to the sync signal regeneration unit 120 and transmits an image signal to the image output unit 130.

The sync signal regeneration unit 120 generates a second sync signal which has a different frequency from a frequency of the first sync signal. For example, the sync signal regeneration unit 120 generates the second sync signal having a frequency that is determined based on units of FRC. In this case, the second sync signal has a frequency in which a number of frames corresponding to a number of FRC units are included in one period.

For example, if an input image signal is a stereoscopic image signal in a 24 Hz frame packing format, the frequency of the first sync signal is 24 Hz. In this exemplary case, the sync signal regeneration unit 120 generates the second sync signal having a 6 Hz frequency.

If a stereoscopic image signal in a 24 Hz frame packing format is FRC-processed into a 60 Hz image, a television may perform FRC for four pairs of left eye image frames and right eye image frames (i.e., a total of eight frames). That is, the television converts four pairs of left eye image frames and right eye image frames (i.e., a total of eight frames) into five pairs of left eye image frames and right eye image frames (i.e., a total of ten frames). In order to include four pairs of left eye image frames and right eye image frames (i.e., a total of eight frames) in a single frequency of a sync signal, the frequency of the second sync signal is to be one fourth of the first sync signal. Accordingly, the frequency of the second sync signal is set to be 6 Hz.

Similarly, if an input image signal is a stereoscopic image signal in a 48 Hz frame sequential format, the frequency of the first sync signal is 48 Hz. In addition, the sync signal regeneration unit 120 generates the second sync signal having a 6 Hz frequency.

If a stereoscopic image signal in a 48 Hz frame sequential format is FRC-processed into a 60 Hz image, a television performs FRC-processing for eight left eye image frames and right eye image frames. That is, the television converts eight left eye image frames and right eye image frames into ten left eye image frames and right eye image frames. In order to include eight left eye image frames and right eye image frames in a single frequency of a sync signal, the frequency of the second sync signal is to be one eighth of the original sync signal. Accordingly, the frequency of the second sync signal is set to be 6 Hz.

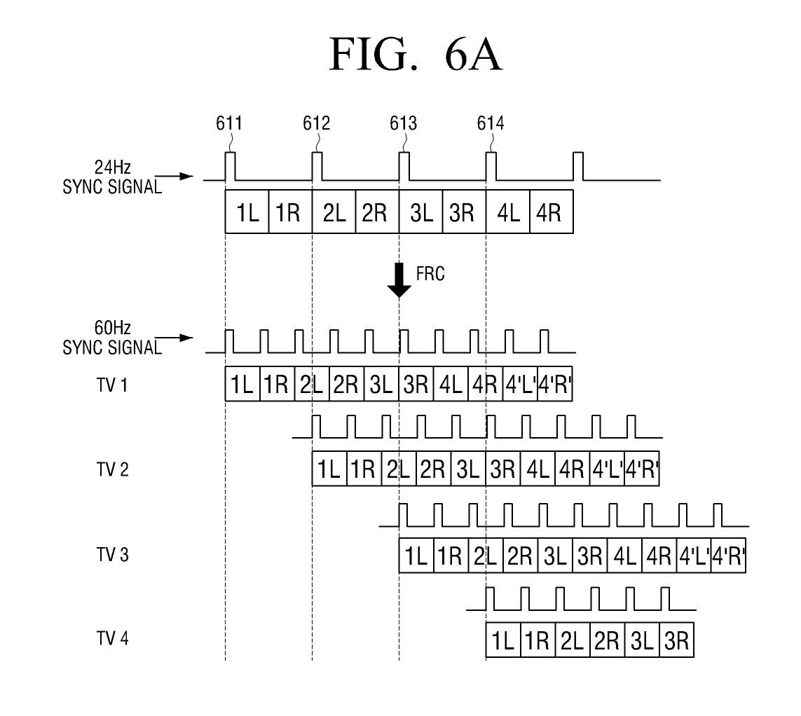

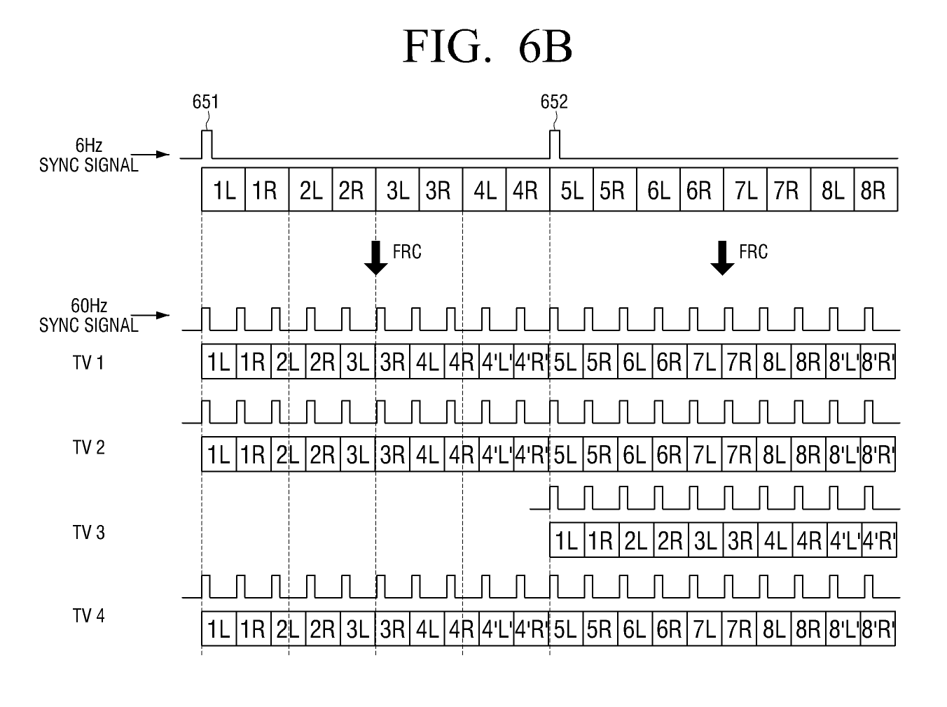

The frequency of the second sync signal generated by the sync signal regeneration unit 120 will be explained in detail below with reference to FIGS. 6A and 6B.

The sync signal regeneration unit 120 may be realized using a hardware structure or a programmable logic, which will be explained with reference to FIGS. 3A and 3B.

FIG. 3A is a view illustrating the sync signal regeneration unit 120 using a latch circuit according to an exemplary embodiment. As illustrated in FIG. 3A, the sync signal regeneration unit 120 includes a first latch circuit 310, a second latch circuit 320 and a switch 330.

The first latch circuit 310 generates a 12 Hz sync signal with respect to an input first sync signal as a reference signal. The second latch circuit 320 generates a 6 Hz sync signal with respect to the first sync signal as a reference signal. Although FIG. 3A illustrates only two latch circuits included in the sync signal regeneration unit 120, it is understood that another exemplary embodiment is not limited thereto. For example, in another exemplary embodiment, any of various kinds of latch circuits may be included to generate sync signals having various frequencies.

The switch 330 selects and outputs a sync signal from among a plurality of input sync signals. The switch 330 selects a frequency to be output based on units of FRC. In this case, the image distributing apparatus 100 may receive information regarding FRC from a connected television and control an operation of the switch 330 based on the received FRC information. Moreover, the switch 330 may output a frequency selected by a user.

As such, the sync signal regeneration unit 120 may be realized using a latch circuit.

FIG. 3B is a view illustrating the sync signal regeneration unit 120 using a programmable logic circuit according to an exemplary embodiment. As illustrated in FIG. 3B, the sync signal regeneration unit 120 comprises a programmable logic circuit 350 and a frequency selection switch 360.

The programmable logic circuit 350 generates a second sync signal of a frequency selected by the frequency selection switch 360 based on an input first sync signal as a reference signal.

The frequency selection switch 360 selects a frequency of a second sync signal which is to be generated from the programmable logic circuit 350. In particular, the frequency selection switch 360 generates a control signal to select a specific frequency and outputs the generated control signal to the programmable logic circuit 350. The frequency selection switch 360 selects the frequency to be output based on units of FRC. In this case, the image distributing apparatus 100 may receive information regarding FRC from a connected television and control an operation of the frequency selection switch 360 based on the received FRC information. Moreover, the frequency selection switch 360 may output frequency selected by a user.

As such, the sync signal regeneration unit 120 may be realized using a programmable logic circuit 350.

Meanwhile, the sync signal regeneration unit 120 may generate the second sync signal if an image signal is a stereoscopic image and output the first sync signal as it is if the image signal is a two-dimensional (2D) image. In particular, if the image signal is a 2D image, the switch 330 of the exemplary embodiment illustrated in FIG. 3A selects the first sync signal as is as the second sync signal. Furthermore, if the image signal is a 2D image, the frequency selection switch 360 of the exemplary embodiment illustrated in FIG. 3B controls the programmable logic circuit 350 to output the first sync signal as is as the second sync signal.

Meanwhile, while in the above-described exemplary embodiments, the sync signal regeneration unit 120 is realized using a latch circuit or a programmable logic circuit, it is understood that another exemplary embodiment is not limited thereto.

As described above, the sync signal regeneration unit 120 generates a second sync signal and outputs the generated sync signal to the image output unit 130.

The image output unit 130 outputs an image signal including the second sync signal. Accordingly, the image output unit 130 outputs the second sync signal simultaneously through a plurality of output ports.

The image output unit 130 may include at least one of various kinds of image interfaces. For example, the image input unit 130 may be include at least one of a DVI interface and an HDMI unit.

As illustrated in FIG. 2, the image output unit 130 may include first through fourth image output ports 131, 132, 133, 134. That is, the image output unit 130 in FIG. 2 includes a total of four output ports, i.e., a first image output port 131, a second image output port 132, a third image output port 133, and a fourth image output port 134. The first image output port 131 is connected to a first television (TV) 210, the second image output port 132 is connected to a second TV 220, the third image output port 133 is connected to a third TV 230, and the fourth image output port 134 is connected to a fourth TV 240.

As described above, the image output unit 130 may output an input image to a plurality of televisions 210, 220, 230, 240 through a plurality of output ports 131, 132, 133, 134.

While in the present exemplary embodiment, four output ports 131, 132, 133, 134 are included in the image output unit 130, it is understood that another exemplary embodiment is not limited thereto. That is, in another exemplary embodiment, any plural number of output ports can be included in the image output unit 130. Moreover, the image output unit 130 may be configured to output a first sync signal as is if an image signal is output from one output port and to output a second sync signal if an image signal is output from more than one output port.

The image distributing apparatus 100 regenerates an input first sync signal as a second sync signal having a frequency that is determined based on FRC units and outputs the regenerated second sync signal. Subsequently, a plurality of televisions 210, 220, 230, 240 which receive the image signal including the second sync signal may synchronize a time when the plurality of televisions 210, 220, 230, 240 display the image even through an FRC process if necessary.

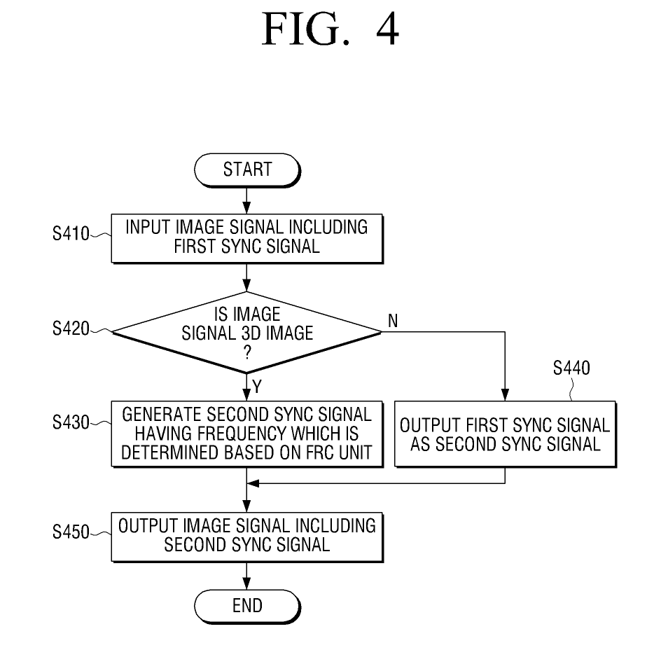

An image distributing method according to an exemplary embodiment will now be explained in detail with reference to FIG. 4. FIG. 4 is a flowchart to explain an image distributing method according to an exemplary embodiment.

Referring to FIG. 4, an image distributing apparatus 100 according to an exemplary embodiment receives an image signal including a first sync signal through an image input unit 110 (operation S410).

The image distributing apparatus 100 determines whether an input image signal is a stereoscopic signal (operation S420). If the input image signal is determined to be a stereoscopic image signal (operation S420-Y), the image distributing apparatus 100 generates a second sync signal having a frequency that is determined based on FRC units (operation S430). In this case, the second sync signal has a frequency in which a number of frames corresponding to the number of units of FRC are included in one period. Accordingly, the frequency of the second sync signal is lower than the frequency of the first sync signal that is a sync signal of an input image.

For example, if an input image signal is a stereoscopic image signal in a 24 Hz frame packing format, the frequency of a first sync signal is 24 Hz. Furthermore, the image distributing apparatus 100 generates a second sync signal having a 6 Hz frequency.

If a stereoscopic image signal in a 24 Hz frame packing format is FRC-processed into a 60 Hz image, a television may perform FRC for four pairs of left eye image frames and right eye image frames (i.e., a total of eight frames). That is, the television converts four pairs of left eye image frames and right eye image frames (i.e., a total of eight frames) into five pairs of left eye image frames and right eye image frames (i.e., a total of ten frames). In order to include four pairs of left eye image frames and right eye image frames (i.e., a total of eight frames) in a single frequency of a sync signal, the frequency of the sync signal is to be one fourth of the original sync signal. Accordingly, the frequency of the second sync signal is set to be 6 Hz.

Similarly, if an input image signal is a stereoscopic image signal in a 48 Hz frame sequential format, the frequency of a first sync signal is 48 Hz. Furthermore, the image distributing apparatus 100 generates a second sync signal having a 6 Hz frequency.

If a stereoscopic image signal in a 48 Hz frame sequential format is FRC-processed into a 60 Hz image, a television performs FRC-processing for eight left eye image frames and right eye image frames. That is, the television converts eight left eye image frames and right eye image frames into ten left eye image frames and right eye image frames. In order to include eight left eye image frames and right eye image frames in a single frequency of a sync signal, the frequency of the sync signal is to be one eighth of the original sync signal. Accordingly, the frequency of the second sync signal is set to be 6 Hz.

In contrast, if the input image signal is determined to not be a 3D image (operation S420-N), the image distributing apparatus 100 outputs the first sync signal as is as the second sync signal (operation S440). That is, the first sync signal and the second sync signal have a same frequency.

Subsequently, the image distributing apparatus 100 outputs an image signal including the second sync signal through at least one output port (operation S450). That is, the image distributing apparatus 100 may output an image signal including the second sync signal to a plurality of external image apparatuses.

Through the above exemplary method, the image distributing apparatus 100 regenerates an input first sync signal as a second sync signal having a frequency that is determined based on FRC units and outputs the generated second sync signal. Subsequently, a plurality of televisions which receive an image signal including the second sync signal may synchronize a time when the plurality of televisions display the image even through an FRC process if necessary.

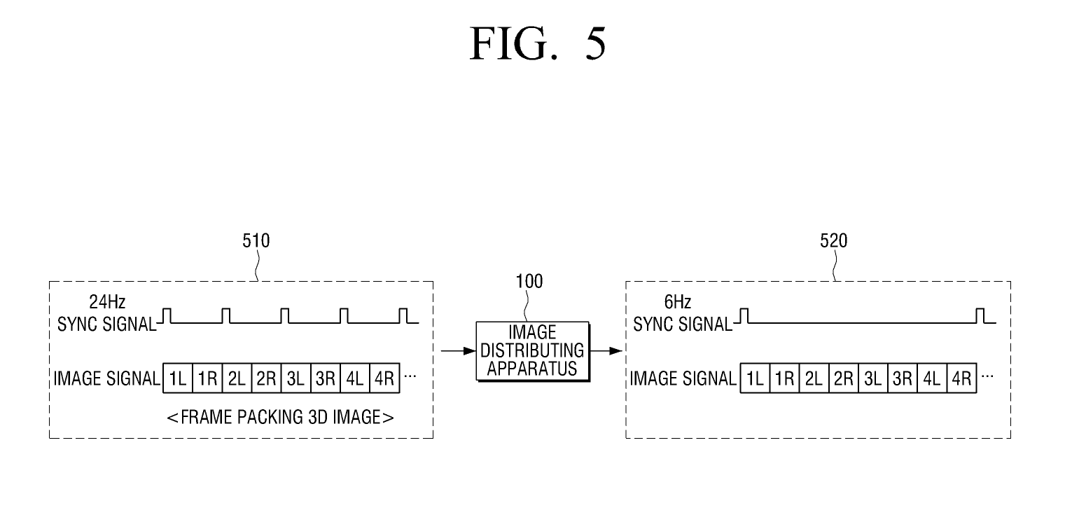

FIG. 5 is a view illustrating an input signal 510 and an output signal 520 of an image distributing apparatus 100 according to an exemplary embodiment.

If an input stereoscopic image is compatible with high definition multimedia interface (HDMI) standards, the stereoscopic image may have a 24 Hz frame packing format according to the HDMI standards. Herein, the 24 Hz frame packing format is one of stereoscopic image formats in which a left eye image frame and a right eye image frame are packed into one frame and transmitted. Accordingly, as illustrated in FIG. 5, the image signal 510 of 24 Hz frame packing includes one left eye image frame and one right eye image frame in each frequency of a sync signal. That is, a first left eye image 1L and a first right eye image 1R are included in a first frequency of the sync signal, a second left eye image 2L and a second right eye image 2R are included in a second frequency of the sync signal, a third left eye image 3L and a third right eye image 3R are included in a third frequency, and a fourth left eye image 4L and a fourth right eye image 4R are included in a fourth frequency.

Accordingly, the image distributing apparatus 100 receives a stereoscopic image having a 24 Hz frame packing format. However, a television may display an image in frequency of 60 Hz. In this case, the stereoscopic image of 24 Hz is converted into a stereoscopic image of 60 Hz through FRC processing. As such, a television converts the frequency of an input stereoscopic image 510 to be suitable for the television through FRC processing.

If a stereoscopic image signal in a 24 Hz frame packing format is FRC-processed into a 60 Hz image, a television performs FRC processing on four pairs of left eye image frames and right eye image frames (i.e., a total of eight frames). That is, the television converts four pairs of left eye image frames and right eye image frames (i.e., a total of eight frames) into five pairs of left eye image frames and right eye image frames (i.e., a total often frames). In order to include four pairs of left eye image frames and right eye image frames (i.e., a total of eight frames) in a single frequency of a sync signal, the frequency of the sync signal is to be one fourth of the original sync signal. Accordingly, the frequency of the second sync signal is set to be 6 Hz.

Therefore, referring to FIG. 5, it can be seen that an image single 520 output from the image distributing apparatus 100 has 6 Hz of sync signal frequency. That is, a total of four pairs of left eye image frames and right eye image frames (i.e., a total of eight frames: <1L, 1R>, <2L, 2R>, <3L, 3R>, <4L, 4R>) are included in a single from of a sync signal.

FRC processing and an operation of an image distributing apparatus 100 according to an exemplary embodiment will now be explained in greater detail with reference to FIGS. 6A and 6B.

FIGS. 6A and 6B are views to compare a case where an image distributing apparatus 100 according to an exemplary embodiment is used to a case where an image distributing apparatus is not used.

FIG. 6A illustrates a case where the image distributing apparatus 100 according to an exemplary embodiment is not applied. That is, FIG. 6A illustrates a case where the image distributing apparatus 100 is not applied and a related art image distributing apparatus outputs an image signal including a 24 Hz sync signal. In this case, the 24 Hz sync signal has the same frequency as an input image.

A television initiates FRC with respect to a sync signal. However, in FIG. 6A, TV1 to TV4 initiate FRC with respect to a different signal of each 24 Hz sync signal. That is, TV1 initiates FRC with respect to a first sync signal 611 of the 24 Hz sync signal, TV2 initiates FRC with respect to a second sync signal 612 of the 24 Hz sync signal, TV3 initiates FRC with respect to a third sync signal 613 of the 24 Hz sync signal, and TV4 initiates FRC with respect to a fourth sync signal 614 of the 24 Hz sync signal.

Furthermore, TV1 to TV4 convert four pairs of frames (i.e., 1L, 1R, 2L, 2R, 3L, 3R, 4L, 4R) into five pairs of frames (i.e., 1L, 1R, 2L, 2R, 3L, 3R, 4L, 4R, 4L′, 4R′) to convert a frame packing image in 24 Hz into a stereoscopic image in 60 Hz.

In this case, it can be seen that TV1 to TV4 do not synchronize the time when a left eye image and a right eye image are displayed with each other. For example, while TV1 is displaying a left eye image 2L, TV2 begins displaying a left eye image 1L. Likewise, the time when a left eye image and a right eye image are displayed is not synchronized with each other in TV2, TV3, and TV4.

Accordingly, if TV1 to TV4 display a stereoscopic image through a related art image distributing apparatus as illustrated in FIG. 6A, a user may not view the stereoscopic image displayed on TV1 to TV4 appropriately with a single pair of 3D glasses.

For example, if the single pair of 3D glasses are synchronized with TV1, a user may view a stereoscopic image displayed on TV1 with the 3D glasses properly, but may not view a stereoscopic image displayed on TV2 to TV4 properly because the time when a left eye image and a right eye image displayed on TV2 to TV4 is not synchronized with the time when left eye glasses and right eye glasses of the 3D glasses are opened and/or closed.

However, if the image distributing apparatus 100 according to an exemplary embodiment is used, as illustrated in FIG. 6B, a time when a left eye image and a right eye image displayed on plural televisions is synchronized.

FIG. 6B illustrates a case where the image distributing apparatus 100 according to an exemplary embodiment is applied. That is, FIG. 6B illustrates a case where an image signal including a 6 Hz sync signal is output by applying the image distributing apparatus 100. That is, in FIG. 6B, the image distributing apparatus 100 receives a 24 Hz image signal and outputs an image signal including a 6 Hz sync signal.

Referring to FIG. 6B, TV1 to TV4 initiate FRC with respect to a sync signal. That is, TV 1 to TV4 initiate FRC with respect to a different signal of each 6 Hz sync signal. In particular, TV1, TV2, and TV4 initiate FRC with respect to a first sync signal 651 of the 6 Hz sync signal and TV3 initiates FRC with respect to a second sync signal 652 of the 6 Hz sync signal.

In addition, TV1 to TV4 convert four pairs of frames (i.e., 1L, 1R, 2L, 2R, 3L, 3R, 4L, 4R) into five pairs of frames (i.e., 1L, 1R, 2L, 2R, 3L, 3R, 4L, 4R, 4L′, 4R′) to convert a frame packing image in 24 Hz into a stereoscopic image in 60 Hz.

In this case, it can be seen that TV1 to TV4 synchronize a time when a left eye image and a right eye image are displayed with each other. For example, although a point of time when TV3 initiates FRC is different from a point of time when TV1, TV2, and TV4 initiate FRC, when TV3 begins displaying a left eye image 1L, TV1, TV2, and TV4 also begin displaying a left eye image 5L. That is, because a sync signal has one frequency corresponding to one unit of FRC, the time when TV1 to TV4 begin displaying a left eye image or a right eye image is consistent.

As such, the image distributing apparatus 100, according to an exemplary embodiment, regenerates a sync signal with a frequency that is determined based on units of FRC such that a time when a plurality of televisions display a stereoscopic image may be synchronized with each other.

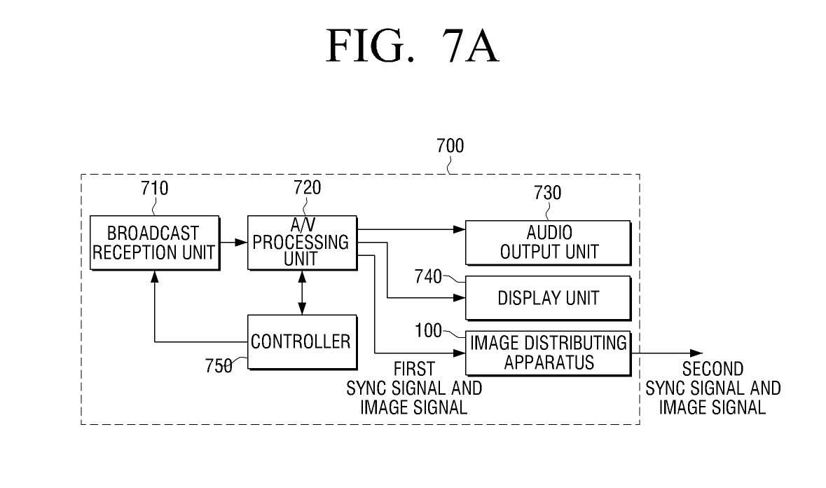

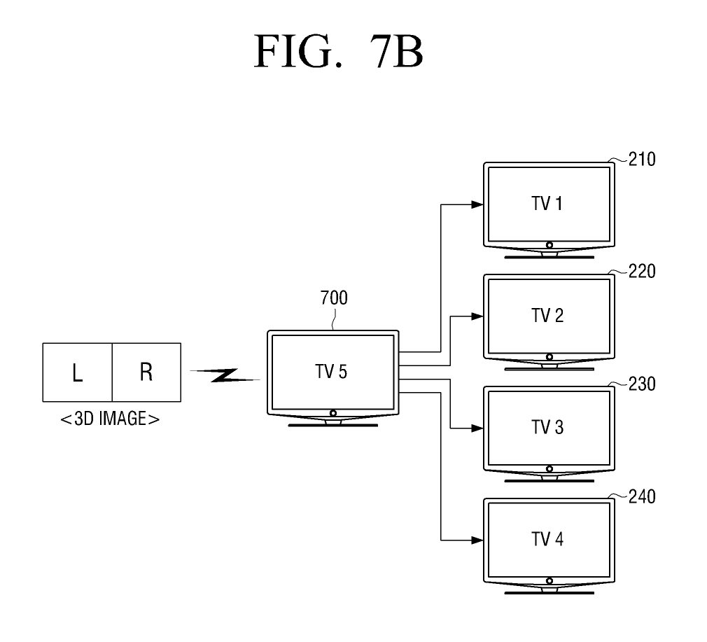

The image distributing apparatus 100 may be a separate apparatus or may be installed in another apparatus. For example, the image forming apparatus 100 may be installed inside a television, as will be explained below with reference to FIGS. 7A to 7B.

FIG. 7A is a block diagram illustrating a television 700 in which an image distributing apparatus 100 is installed according to an exemplary embodiment. Referring to FIG. 7A, the television 700 includes a broadcast reception unit 710, an audio/video (A/V) processing unit 720, an audio output unit 730, a display unit 740, a controller 750, and the distributing apparatus 100.

The broadcast reception unit 710 receives a broadcast signal via at least one of a wired and a wireless transmission. In addition, the broadcast reception unit 710 transmits the received broadcast signal to the A/V processing unit 720.

The A/V processing unit 720 divides the received broadcast signal into an audio signal and a video signal and performs signal-processing on the audio signal and the video signal respectively. Moreover, the A/V processing unit 720 transmits the processed audio signal to the audio output unit 730 and the processed video signal to the display unit 740 and the image distributing apparatus 100.

The audio output unit 730 outputs the audio signal to a speaker, headphones, etc.

The display unit 740 displays the image signal on a screen.

The controller 750 controls overall operations of the TV 700, performs basic operations of the TV 700, and controls an operation according to a user's command.

The image distributing apparatus 100 may have a configuration which is the same as or similar to that illustrated in FIG. 2, and converts an image signal including a first sync signal into an image signal including a second sync signal and outputs the converted image signal through at least one output port.

FIG. 7B is a view illustrating an image distributing system including the television 700 in which the image distributing apparatus 100 is installed according to an exemplary embodiment. Referring to FIG. 7B, the TV 700 may output a received stereoscopic image to TV1 210, TV2 220, TV3 230, and TV4 240. That is, the TV 700 may perform operations of an image distributing apparatus.

Through the above processes, the TV 700 may display a broadcast program and transmit a received broadcast program to another display apparatus simultaneously. In particular, since the image distributing apparatus 100 generates a second sync signal based on units of FRC, a different display apparatus connected to the TV 700 may be synchronized with the TV 700 to display an image.

While the above-described exemplary embodiment receives an image signal via a broadcast signal, it is understood that another exemplary embodiment is not limited thereto, and may receive the image signal from a reproducing apparatus, a remote distribution, etc.

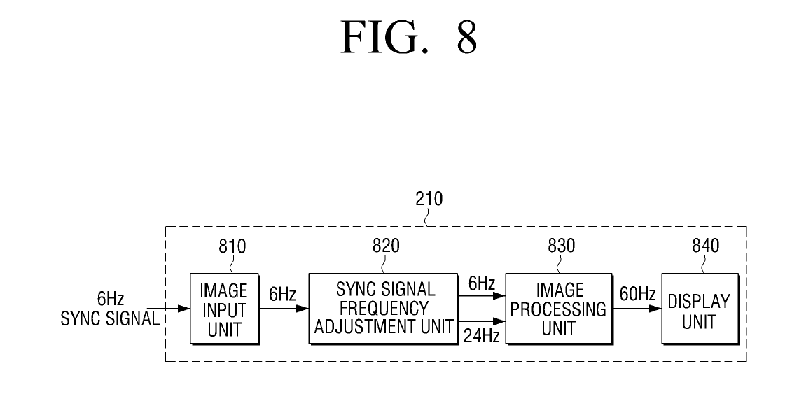

FIG. 8 is a block diagram illustrating a configuration of a TV 210 which receives an image signal from an image distributing apparatus and displays the received image signal according to an exemplary embodiment. The configuration illustrated in FIG. 8 may be applied to any of TV1 210, TV2 220, TV3 230, and TV4 240 of FIG. 7B.

Referring to FIG. 8, the TV 210 includes an image input unit 810, a sync signal frequency adjustment unit 820, an image processing unit 830, and a display unit 830.

The image input unit 810 receives an image signal from an external apparatus. In particular, the image input unit 810 receives an image signal including a sync signal of a second frequency (for example, 6 Hz) from a image distributing apparatus 100 according to an exemplary embodiment.

The sync signal frequency adjustment unit 820 adjusts the received sync signal of the second frequency (for example, 6 Hz) to become a sync signal of a first frequency (for example, 24 Hz) again. The sync signal frequency adjustment unit 820 may be realized using a latch circuit or a programmable logic circuit.

The image processing unit 830 performs image-processing such as FRC processing and scaling on an image signal output from the sync signal frequency adjustment unit 820. Furthermore, if an input image is a stereoscopic image, the image processing unit 830 may perform stereoscopic image processing to generate a left eye image and a right eye image based on the input image signal.

In this case, the image processing unit 830 initiates FRC processing with respect to a sync signal of a second frequency (for example, 6 Hz) input to the image input unit 810. For example, if a 24 Hz image is input, the image processing unit 830 performs FRC processing with respect to a 6 Hz sync signal to convert the input image into a 60 Hz image.

The display unit 840 displays a processed image on the screen. In addition, if an input image is a stereoscopic image, the display unit 840 displays a left eye image and a right eye image alternately.

Since the TV 210 having the above configuration performs FRC with respect to a sync signal of a second frequency output from the image distributing apparatus 100, the TV 210 may synchronize a time when a left eye image and a right eye image of a stereoscopic image are displayed with that of other televisions.

In the above exemplary embodiment, a display apparatus is described as a television. However, it is understood that another exemplary embodiment is not limited thereto, and any apparatus which can display an image may be provided as a display apparatus. For example, a display apparatus may be a monitor, a portable multimedia player (PMP), etc.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, while not required in all aspects, one or more units of the image distributing apparatus 100 and TV 201 can include a processor or microprocessor executing a computer program stored in a computer-readable medium.

Although a few exemplary embodiments have been shown and described, it would be appreciated by those skilled in the art that changes may be made in the exemplary embodiments without departing from the principles and spirit of the inventive concept, the scope of which is defined in the claims and their equivalents.

What is claimed is:

1. An image distributing apparatus, comprising:
an image input unit which receives an input signal comprising an image signal and a first sync signal for synchronizing a display of the image signal;
a sync signal regeneration unit which generates a second sync signal for synchronizing the display of the image signal and having a frequency that is different from a frequency of the first sync signal; and
an image output unit comprising at least one output port to output the image signal and the second sync signal.

2. The apparatus as claimed in claim 1, wherein the sync signal regeneration unit determines the frequency of the second sync signal based on a frame rate conversion (FRC) unit.

3. The apparatus as claimed in claim 2, wherein the sync signal regeneration unit generates the second sync signal having the frequency in which a number of frames corresponding to a number of FRC units are included in one period.

4. The apparatus as claimed in claim 1, wherein:
the image signal is a stereoscopic image in a 24 Hz frame packing format;
the frequency of the first sync signal is 24 Hz; and
the frequency of the second sync signal is 6 Hz.

5. The apparatus as claimed in claim 1, wherein:
the image signal is a stereoscopic image in a 48 Hz frame sequential format;
the frequency of the first sync signal is 48 Hz; and
the frequency of the second sync signal is 6 Hz.

6. The apparatus as claimed in claim 1, wherein the sync signal regeneration unit generates the second sync signal if the image signal is a stereoscopic image and outputs the first sync signal as is without generating the second sync signal having the different frequency if the image signal is not the stereoscopic image.

7. The apparatus as claimed in claim 1, wherein the sync signal regeneration unit comprises a latch circuit which generates the second sync signal.

8. The apparatus as claimed in claim 1, wherein the sync signal regeneration unit comprises a programmable logic circuit which generates the second sync signal.

9. The apparatus as claimed in claim 1, wherein the first sync signal is a vertical (V) sync comprised in the image signal.

10. The apparatus as claimed in claim 1, wherein the image input unit and the image output unit are compatible with at least one HDMI standard.

11. The apparatus as claimed in claim 1, wherein the image output unit comprises a plurality of output ports, and the second sync signal is simultaneously output from the plurality of output ports.

12. The apparatus as claimed in claim 1, wherein the sync signal regeneration unit receives the first sync signal from the image input unit and generates the second sync signal from the first sync signal.

13. An image distributing method, comprising:
receiving an input signal comprising an image signal and a first sync signal for synchronizing a display of the image signal;
generating a second sync signal for synchronizing the display of the image signal and having a frequency that is different from a frequency of the first sync signal; and
outputting the image signal and the second sync signal through at least one output port.

14. The method as claimed in claim 13, wherein the generating comprises determining the frequency of the second sync signal based on a frame rate conversion (FRC) unit.

15. The method as claimed in claim 14, wherein the generating comprises generating the second sync signal having the frequency in which a number of frames corresponding to a number of FRC units are included in one period.

16. The method as claimed in claim 13, wherein:
the image signal is a stereoscopic image in a 24 Hz frame packing format;
the frequency of the first sync signal is 24 Hz; and
the frequency of the second sync signal is 6 Hz.

17. The method as claimed in claim 13, wherein:
the image signal is a stereoscopic image in a 48 Hz frame sequential format;
the frequency of the first sync signal is 48 Hz; and
the frequency of the second sync signal is 6 Hz.

18. The method as claimed in claim 13, wherein the generating comprises:
determining whether the image signal is a stereoscopic image;
generating the second sync signal if the image signal is the stereoscopic image; and
outputting the first sync signal as is without generating the second sync signal if the image signal is not the stereoscopic image.

19. The method as claimed in claim 13, wherein the generating comprises generating the second sync signal using a latch circuit.

20. The method as claimed in claim 13, wherein the generating comprises generating the second sync signal using a programmable logic circuit.

21. The method as claimed in claim 13, wherein the first sync signal is a vertical (V) sync comprised in the image signal.

22. The method as claimed in claim 13, wherein the image signal is compatible with at least one HDMI standard.

23. The method as claimed in claim 13, wherein the outputting comprises simultaneously outputting the second sync signal through a plurality of output ports.

24. The method as claimed in claim 23, wherein the simultaneously outputting comprises simultaneously outputting the second sync signal to a plurality of display apparatuses.

25. A display apparatus comprising the image distributing apparatus of claim 1.

26. An image distributing method, comprising:
receiving a first sync signal for synchronizing a display of an image signal;
generating a second sync signal for synchronizing the display of the image signal and having a frequency that is different from a frequency of the first sync signal; and
outputting the second sync signal through at least one output port.

27. The image distributing method as claimed in claim 26, wherein the outputting the second sync signal comprises outputting the second sync signal to a plurality of display apparatuses to sync the display of the image signal on the plurality of display apparatuses.

28. The image distributing method as claimed in claim 26, wherein the second sync signal synchronizes a display of a reference viewpoint and an additional viewpoint of the image signal on a plurality of display apparatuses.

29. A computer readable recording medium having recorded thereon a program executable by a computer for performing the method of claim 13.

30. A computer readable recording medium having recorded thereon a program executable by a computer for performing the method of claim 26.
